(19) United States
(12) Patent Application Publication
(10) Pub. No.: US 2015/0047257 A1
(43) Pub. Date: Feb. 19, 2015

(54) FABRIC PLANT POT

(71) Applicant: Daniel AGER, San Geronimo, CA (US)

(72) Inventor: Daniel AGER, San Geronimo, CA (US)

(21) Appl. No.: 13/969,511

(22) Filed: Aug. 17, 2013

(51) Int. Cl. A01G 9/02

(52) U.S. Cl. CPC A01G 9/02
USPC 47/65.8

(57) ABSTRACT

A plant container for reducing root circling and promoting air pruning comprising an open top portion, a closed bottom portion, a closed sidewall and a pair of handles woven on either side of the sidewall. The container is made of non-woven geotextile fabric for providing higher air and water permeability for effective plant growth. The fabric promotes air pruning which boosts natural apical dominance of the roots leading to additional root branching. A skeletal support is provided internally or externally to provide a rigid internal structure to the fabric. The rigid internal structure helps easy filling, irrigating, moving and maintaining of the plant container. A pair of hook and loop-type fasteners helps the plant container to remain in a collapsed position when not used. In an alternate embodiment, the sidewalls are formed by vertical skeletal supports or rings enveloped in fabric where borders are sewn together.

### CROSS-REFERENCE TO RELATED APPLICATION

This application claims the benefit of priority of non-provisional patent application Ser. No. 13457921 filed on May 9, 2012, which in turn claims the benefit of non-provisional patent application Ser. No. 13/227,389 filed on Jul. 9, 2011, which further claims priority to provisional patent application No. 61380420 filed on Sep. 7, 2010. The earliest priority date claimed is Sep. 7, 2010.

### FEDERALLY SPONSORED RESEARCH

Not Applicable

SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to plant containers and more particularly to plant containers made of fabric for growing plants.

A wide variety of plant containers made of plastic, clay, Terracotta, stone, cast iron and even aluminum are available for growing plants. Some containers are porous and some are non porous. Different containers have different water holding characteristics.

Various attempts have been made to address problems with growing plants in containers. For example, as in U.S. Pat. No. 20070157513 published to Varney on Jul. 12, 2007 defines a plant pot having a sleeve and a base disposed across one end of the sleeve, the sleeve and base together forming a container for holding potting soil. The sleeve is formed from a flexible membrane that is both permeable to air and water vapor, and impermeable to liquid water, enabling aeration of the soil through the sleeve while inhibiting liquid water transfer across the fabric.

Another prior art, described in U.S. Pat. No. 5,768,825 issued to Reiger on Jun. 23, 1998, describes a plant preservation and growth control bag and method of using the bag. The bag includes an open top, a tapered side, a bottom and is formed from a porous fabric which catches plant roots and prevents root circulation, induces root branching within the bag and resists substantial root penetration. The bag is used in accordance with the method of the invention for preserving a plant while restricting its growth after initially growing the plant in the ground and removing for transplantation.

Similarly U.S. Pat. No. 20090107041 published to Hughes on Apr. 30, 2009, describes a plant pot comprising a base and at least one side wall, the base and the side wall together defining at least one chamber of fixed dimensions for receiving at least one plant and a growing medium, wherein a plurality of apertures are formed in at least one side wall, each aperture permitting passage of a root of the at least one plant from the chamber through the side wall to an exterior of the plant pot. Plants, typically trees, are normally grown in such pots in the ground and their extraction for onward sale is facilitated by the use of such pots.

All of the patents discussed above have considerable drawbacks for providing adequate aeration and moisture content in the plant container due to the absence of non-woven geotextile as the fabric. The presence of a woven or non- woven geotextile fabric reduces root circling and promotes air pruning. Since most of the conventional plant containers are made of clay, plastic, terracotta and similar materials, it is difficult to provide sufficient aeration and moisture content for an extended period of time. Moreover, current fabric “grow bags” lack a skeletal structure and therefore are more difficult to fill, transplant out of, and subject plants to damage during transport.

Therefore, there is a need for a container that provides adequate aeration and moisture content in a plant container for an extended period of time. Such a needed container made with a geotextile fabric would provide better growth for plants, and improve the survivability of plants in containers. The fabric is made of a rigid skeletal structure to remain collapsible for storage, shipping and cleaning purposes. For growers wishing the benefit of air pruning of the roots, but decreasing moisture transmission through the fabric of the pot, the outer surface of the fabric can be heat-sealed or thermal bonded. Thermal bonding the outer surface increases the resistance against the roots growing through the fabric of the pot, while also retaining more water. This would be beneficial for plants requiring increased moisture to roots. Alternatively, the outer layer can be lightly thermal bonded or not. This embodiment may be preferably for those wishing to retain the plant in the original fabric plant pot to be later transplanted into the ground or a larger pot. By retaining the plant in the original fabric plant pot, “plant shock” (damage to a plant being stripped from a pot) can be avoided. Moreover, a fully biodegradable pot with biodegradable wire skeletal structure and biodegradable geotextile fabric may be desirable. The present invention accomplishes these objectives.

### SUMMARY

The present invention is a plant container for reducing root circling and promoting air pruning comprising an open top portion, a closed bottom portion, a side wall extending from the open top portion to the closed bottom portion and a pair of handles woven on either side of the closed side wall for easy transport. The open top portion, the closed bottom portion and the closed side wall defines the container. Since the plant container is made of fabric it provides higher air and water permeability for effective growth of plants. The fabric is a geotextile fabric or similar fabric, woven or non-woven, which exhibits the desired qualities mentioned. The fabric promotes air pruning which boosts natural apical dominance of the roots leading to additional root branching and thus maintaining the plant with more healthy and robust root structure. It also promotes rapid and uniform evaporation of moisture thereby exhibiting a unique wicking property that helps water and nutrient movement up the fabric. The most beneficial property of the fabric is that it reduces or eliminates root circling which is harmful to the plant. The open top portion, the closed bottom portion and the closed side wall provides a substantially cylindrical shape to the plant container. The shape can be deviated based on the plant root requirements. A pair of posterior handles can also be provided optionally for extra support.

A skeletal support is provided internally or externally to provide a rigid internal structure to the fabric. The rigid internal structure helps easy filling, irrigating, moving and maintaining of the plant container. The skeletal support may include a wire, plastic or any other malleable material which exhibits spring-like qualities. The skeletal support can be woven with a string like or thread like material on the inside or outside of the sides of the plant container. The skeletal support can also be threaded through a spiral shaped sleeve woven around the fabric. The threaded connection may be connected with any other suitable glue or adhesive. The skeletal support may maintain its structural shape and spring-like qualities by a point of contact overlap at the top and bottom of the plant container. In addition, the presence of a skeletal support helps to provide a collapsible system that can be easily stored and shipped. A pair of hook and loop-type fasteners is attached to the inner part of the closed bottom portion or to the open top portion to keep the container in the collapsed position. The plant container can be placed in a collapsed position by folding the closed side wall of the plant container and attaching the pair of hook and loop-type fasteners placed to the inner part of the closed bottom portion or to the open top portion to that of the hook and loop-type fasteners placed at the outer part of the closed bottom portion. The pair of hook and loop-type fasteners helps the plant container to remain in the collapsed position during storage or shipping. Other types of fasteners like strings or elastic can be used to help keep the pot collapsed. The closed bottom portion of the plant container is both water permeable and air permeable. The permeable nature of the closed bottom portion would allow it to be manufactured either with or without holes depending on the drainage qualities of the container. The closed bottom portion may be treated with resin or other treatment to provide resistance to wear and tear. The outer layer may be highly or lightly thermal bonded or non-thermal bonded depending on the type of plant to be placed in the plant container or desired plant pot qualities.

### BRIEF DESCRIPTION OF THE FIGURES

FIG. 1 shows a perspective view of a plant container.

FIG. 2A shows a top perspective view of the plant container showing an internally placed skeletal support and a pair of hook and loop type fasteners tied to the closed bottom part of the container to keep the container in the collapsed position.

FIG. 2B shows a top perspective view of the same plant container, but with the pair of hook and loop type fasteners tied to the open top portion of the container, which may also serve to hold utility items.

FIG. 3A-3B shows the plant container in which the pair of hook and loop-type fasteners keeps the container in a collapsed position forming a pancake structure.

FIG. 4 shows the plant container in the upside down position with a pair of hook and loop-type fasteners attached to the bottom closed portion.

FIGS. 5A and 5B show another embodiment in which the hook and loop type fasteners function as straps that travel across the top rim and attach on the opposite side of the open top portion.

FIG. 5C shows that the skeletal structure is flexible enough to allow a larger plant container to be twisted and folded so that the surface area of the pancake structure is smaller.

FIG. 6 shows an example of the plant container with vertical skeletal supports, forming multiple walls whose open top portion and closed bottom portion are continuously attached to the side walls.

FIG. 7 shows an alternate embodiment of the invention consisting of rigid rings enveloped in fabric that form sidewalls. Each of the sidewalls is sewn together so that the fabric plant pot can take on a cube shape.

FIG. 8 shows the same alternate embodiment with eight sidewalls sewn together forming a fabric plant pot with an octagonal shape.

FIG. 9 shows a plant container with skeletal supports extending past the upper rim for structural support of plant stalks and branches.

FIG. 10A-B shows a means for opening a sidewall for easy dirt removal or transplanting.

FIG. 11A-C shows another means for opening a sidewall for easy dirt removal or transplanting.

FIG. 12 shows an alternate embodiment in which vertical, horizontal, and/or spiral skeletal supports can be removed for easy washing and storage.

### REFERENCE NUMERALS

10 . . . Plant container

12 . . . Open top portion

14 . . . Closed bottom portion

16 . . . Side wall

18 . . . Handles

20 . . . Skeletal support

22 . . . hook and loop-type fasteners

24 . . . utility item

30 . . . Another embodiment

32 . . . Open top portion

34 . . . Bottom portion with a hole cut out at the centre

36 . . . Side wall

38 . . . Handles

39 . . . Rigid Rings

40 . . . means for opening a plant container

### DETAILED DESCRIPTION

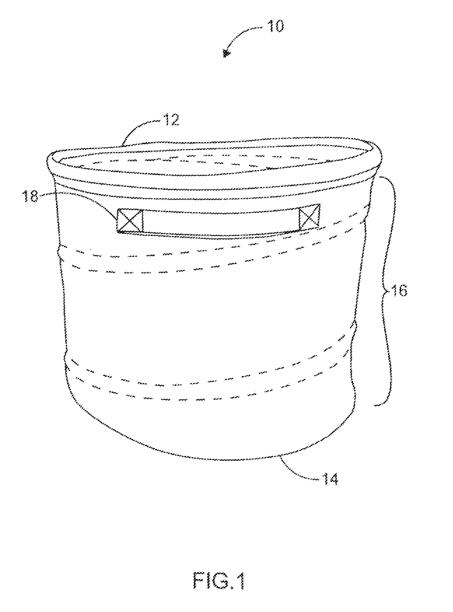

FIG. 1 shows a perspective view of a plant container 10. The plant container 10 for reducing root circling and promoting air pruning comprises an open top portion 12, a closed bottom portion 14, a side wall 16 extending from the open top portion 12 to the closed bottom portion 14 and a pair of handles 18 woven on either side of the closed side wall 16 for easy transport. The open top portion 12, the closed bottom portion 14 and the closed side wall 16 defines the container 10. Since the plant container 10 is made of fabric it provides higher air and water permeability for effective growth of plants. The fabric is a specific woven or non-woven geotextile fabric. The fabric promotes air pruning which boosts natural apical dominance of the roots leading to additional root branching and thus maintaining the plant with more healthy and robust root structure. It also promotes rapid and uniform evaporation of moisture thereby exhibiting a unique wicking property that helps water and nutrient movement up the fabric. The most beneficial property of the fabric is that it reduces or eliminates root circling which is harmful to the plant. The open top portion 12, the closed bottom portion 14 and the closed side wall 16 provides a substantially cylindrical shape to the plant container 10. The shape can be deviated based on the plant root requirements. A pair of posterior handles (not shown) can also be provided optionally for extra support. The plant container 10 can be made in a wide range of sizes for example 1 gallon, 3 gallon, 5 gallon, 10 gallon, 15 gallon, 30 gallon, 50 gallon, etc.

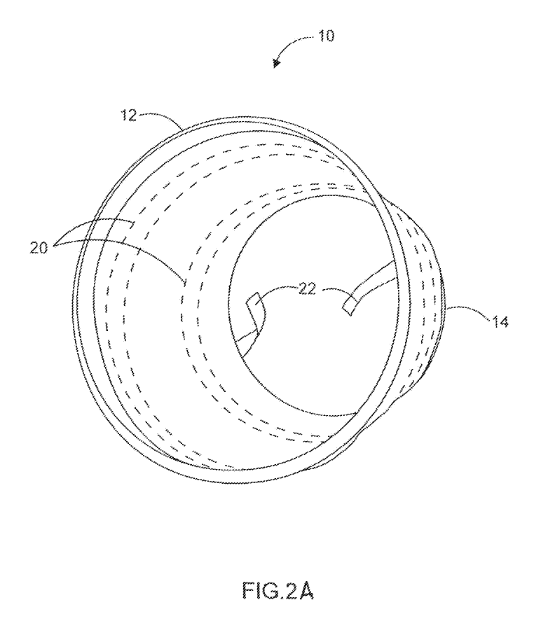

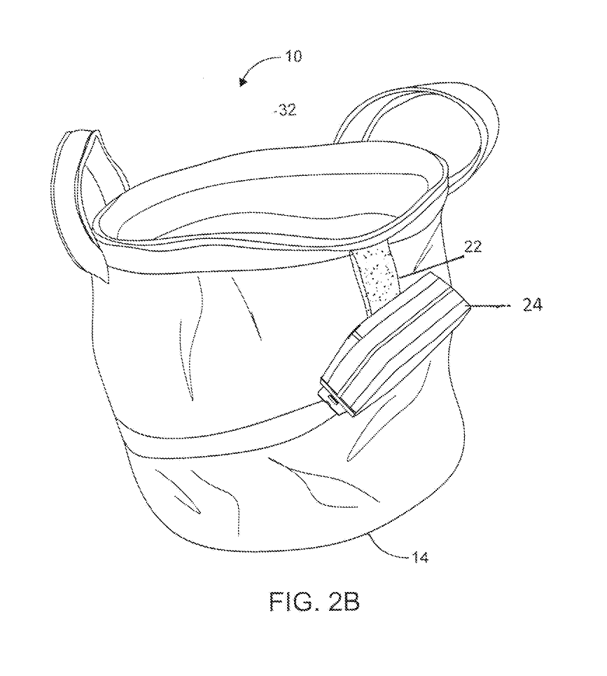

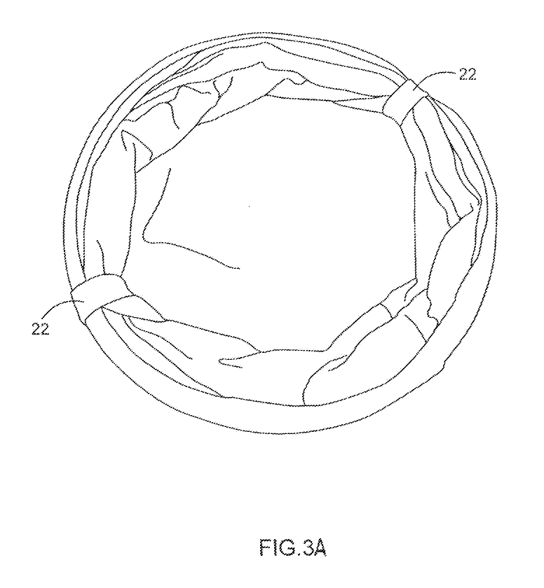

FIG. 2A shows a top perspective view of the plant container 10 showing an internally placed skeletal support 20 and a pair of hook and loop-type fasteners 22. The skeletal support 20 is provided internally or externally to provide a rigid internal structure to the fabric. The rigid internal structure helps with easy filling, irrigating, moving and maintaining of the plant container 10. The skeletal support 20 may include a wire, plastic or any other malleable material which exhibits spring-like qualities. The skeletal support 20 can be woven with a string-like or thread-like material on the inside or outside of the sides of the plant container 10. The skeletal support 20 can also be threaded through a spiral shaped sleeve woven around the fabric. The threaded connection may be connected with any other suitable glue or adhesive. The skeletal support 20 may maintain its structural shape and spring-like qualities by a point of contact overlap at the top and bottom of the plant container 10. In addition, the presence of the skeletal support 20 helps to provide a collapsible system that can be easily stored and shipped. A pair of hook and loop-type fasteners 22 is attached to the inner part of the closed bottom portion 16.

FIG. 2B shows a perspective view of the preferred embodiment of the plant container 10, with the pair of hook and loop type fasteners 22 attached to the open top portion 32 of the plant container 10. In this way, the hook and loop type fasteners 22 do not degrade when dirt is placed inside the plant container 22. Moreover, the hook and loop type fasteners can be used to hold drip irrigation lines, act as tie-down points for branch bending/cropping or hold utility items 24 such as irrigation lines, plant ties, tape, garden sheers, pruners, etc. The pair of hook and loop type fasteners can form a loop to hold utility items 24 and attach to itself, and can also attach to corresponding hook and loop type fasteners at the outer surface of the closed bottom portion 14 of the plant container 10.

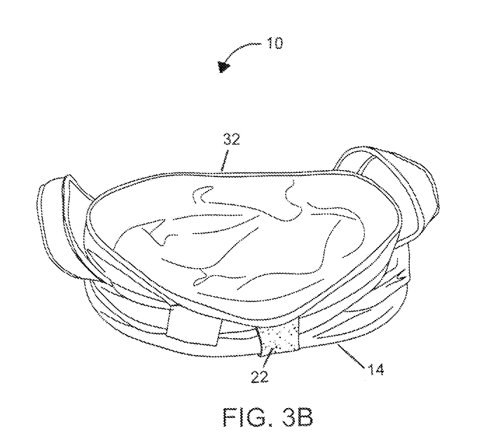

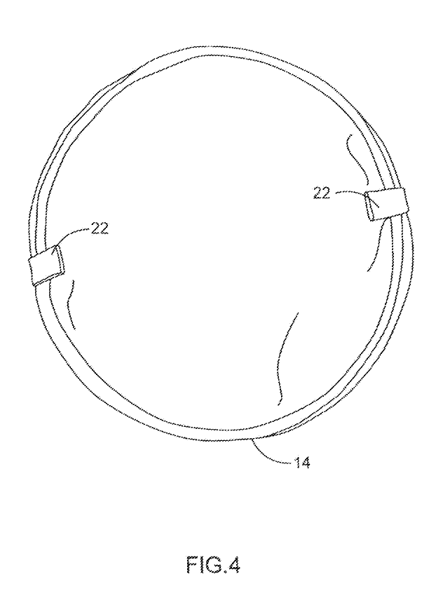

FIG. 3A shows the plant container in which the pair of hook and loop-type fasteners is tied to the closed bottom part of the container to keep the container in the collapsed position. The plant container 10 can be placed in a collapsed position by folding the closed side wall 16 of the plant container 10 and attaching the pair of hook and loop-type fasteners 22 placed to the inner surface of the closed bottom portion 14 to that of the hook and loop-type fasteners 22 placed at the outer surface of the closed bottom portion 14. The pair of hook and loop-type fasteners 22 helps the plant container 10 to remain in the collapsed position for storage or shipping. Likewise, if the pair of hook and loop type fasteners are disposed on the open top portion 32 of the plant container 10, the pair would attach to a corresponding pair of hook and loop type fasteners at the outer surface of the closed bottom portion 14 as seen in FIG. 3B.

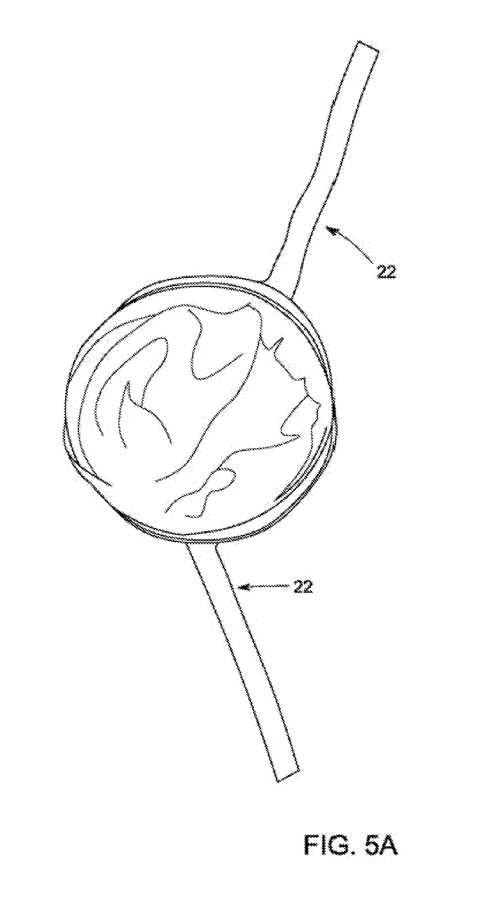

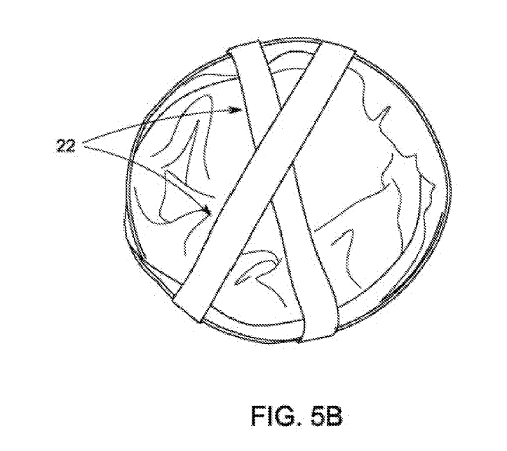

FIG. 4 shows the plant container 10 in the upside down position with the pair of hook and loop-type fasteners 22 attached to the outer surface of the closed bottom portion 14. The closed bottom portion 14 of the plant container 10 is both water permeable and air permeable. The permeable nature of the closed bottom portion 14 would allow it to be manufactured either with or without holes depending on the drainage qualities of the container. The closed bottom portion 14 may be treated with resin or other treatment to provide resistance to wear and tear.

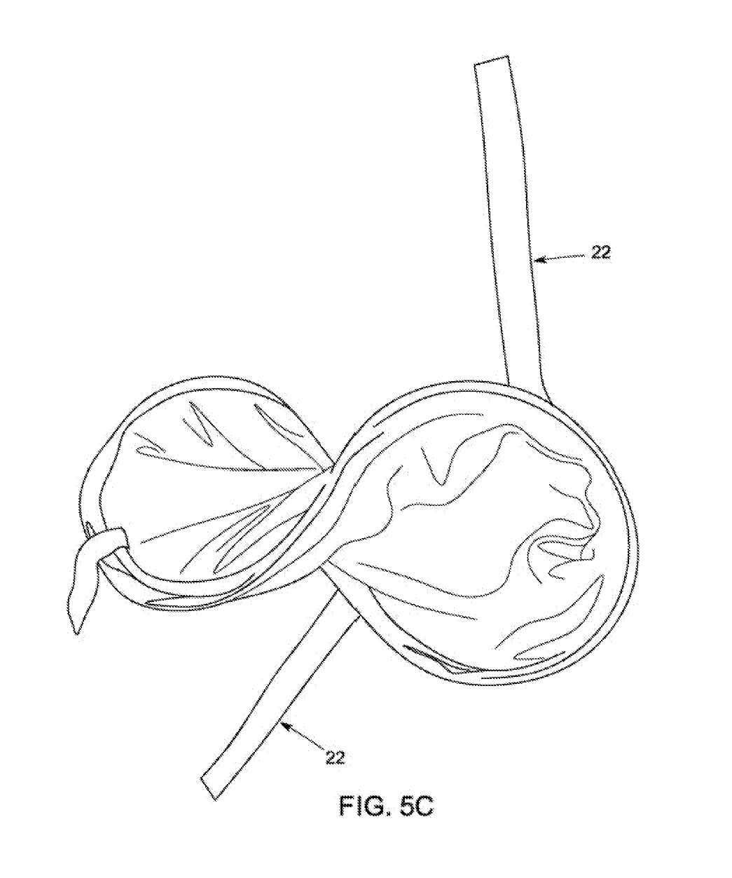

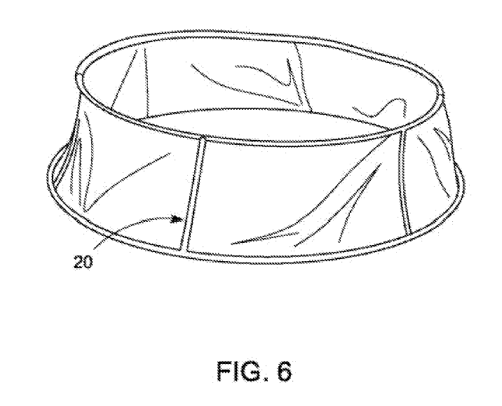

It should be understood that the pair of hook and loop type fasteners can be a strip of hook and loop type fasteners, or a strip of fabric comprising hook and loop type fasteners. However, as seen in FIGS. 5A and 5B, the hook and loop type fasteners may form part of a strap, long enough to fold across the open top portion and attach to another side of the open top portion. These straps have a skeletal support structure sewn inside, which can be the same skeletal support structure that gives the sidewalls rigidity. For a plant container 10 with a larger diameter, as seen in FIG. 5C, the skeletal support 20 of malleable material allows the plant container to be twisted into a figure eight and then folded so that the circumference of the plant container is smaller. This makes the plant container more compact for easier transport or storage. The straps with hook and loop type fasteners fold across the folded portion to maintain the compact structure of the folded figure eight.

FIG. 6 shows the plant container with wires forming vertical supports in lieu of the spiral formation of FIG. 2A. The vertical supports are perpendicular to a top and/or bottom portion of the plant container and allows the plant container to form a container shape.

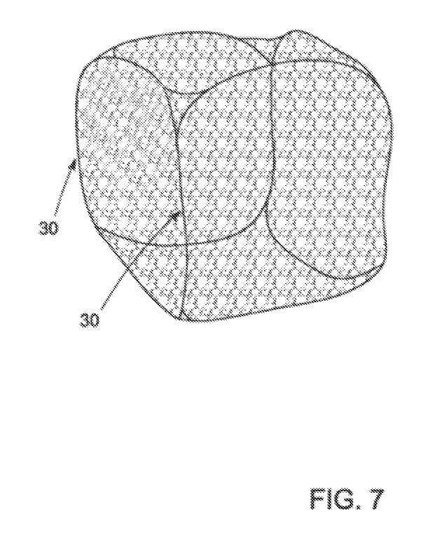

FIG. 7 shows an alternate embodiment of the invention, which consists of rigid rings of fiberglass, plastic, metal, or other rigid material. Each of the rings are enveloped in fabric, so that the rings form side walls. The fabric immediately surrounding the rings forms the borders of the side walls. The borders of each sidewall are sewn to the borders of an adjacent sidewall so that the plant pot can take various geometric shapes depending on the number of rings sewn together. FIG. 7 shows a cube shape. Each sidewall can be collapsed, so that the overall shape of the collapsed pot is the same shape and size of one sidewall. The sidewall rings can also be flexible enough (similar to FIG. 5c) such that the collapsed sidewall can be further folded to make the folded container even more compact.

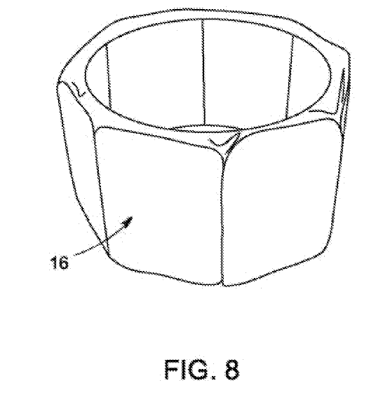

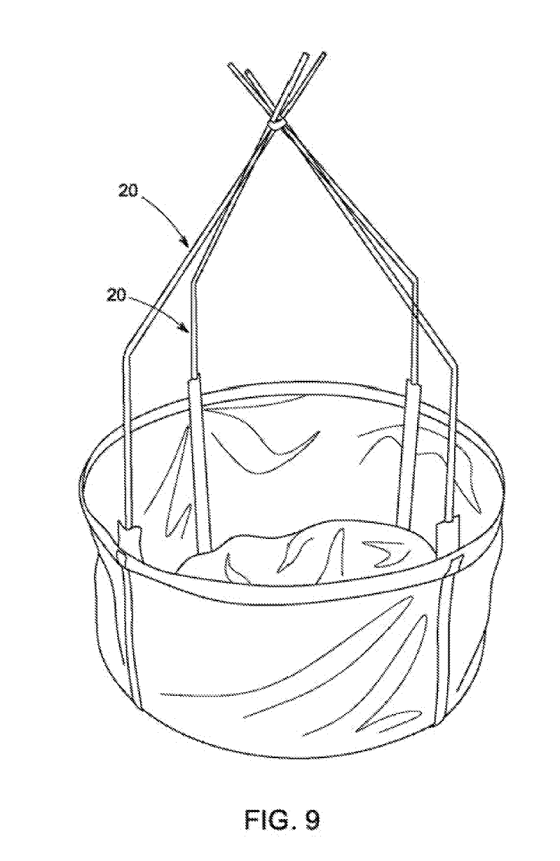

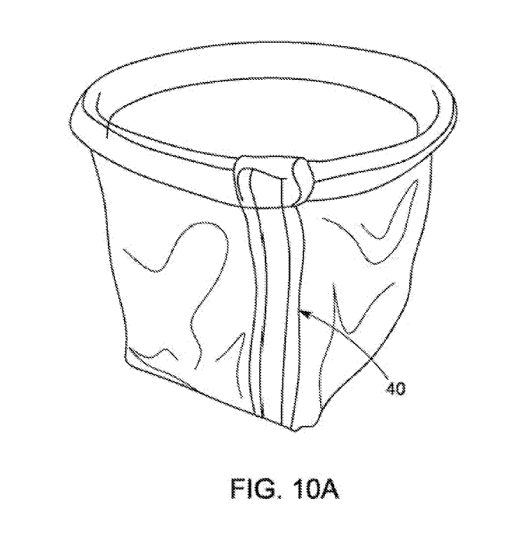

FIG. 8 shows the same alternate embodiment, but with eight sidewalls enveloped in fabric, forming eight sidewalls sewn together at the borders. The overall shape of the fabric plant pot is octagonal. The top of the fabric plant pot consists of folded over fabric that resists the overexpansion of the fabric plant pot, and helps to maintain the fabric plant pot in an upright position. Like FIG. 7, FIG. 8 can be collapsed down to the shape and size of one sidewall.

FIG. 9 shows an embodiment with a skeletal structure that extends past the upper rim of the container to form a structural support for the plant stalk and branches themselves.

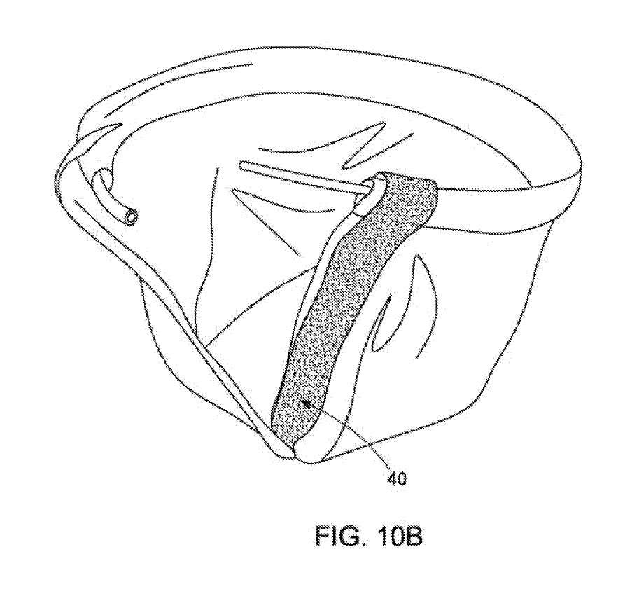

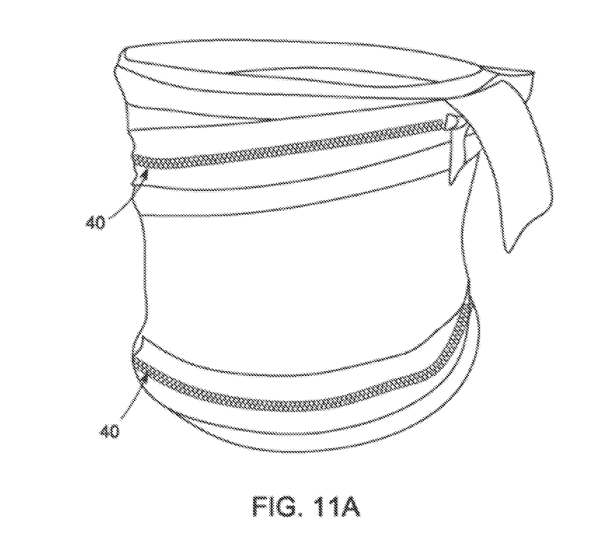

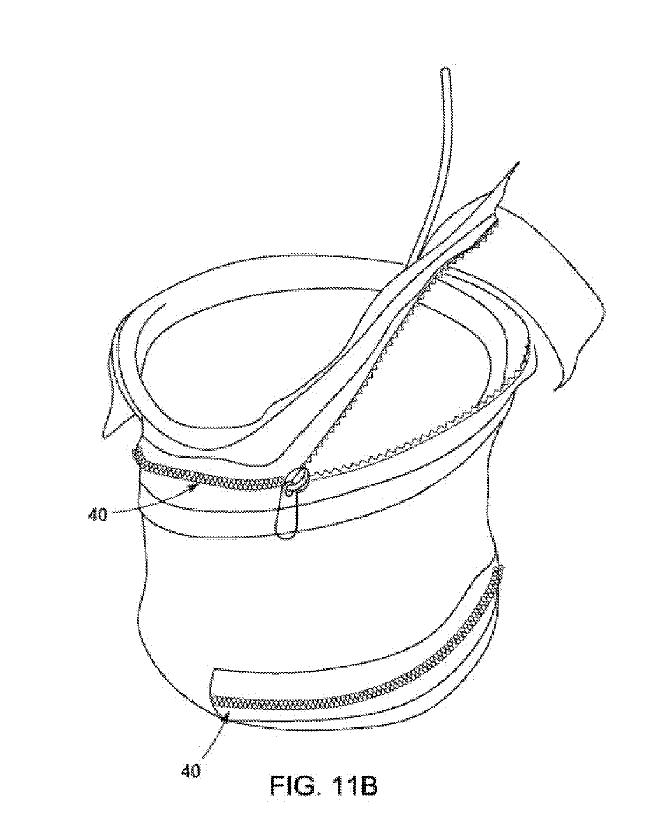

FIGS. 10A-B show an embodiment with a sidewall containing a means for opening a plant container for easy dirt removal and/or transplanting, such as zippers, ties, hook and loop type fasteners, etc..

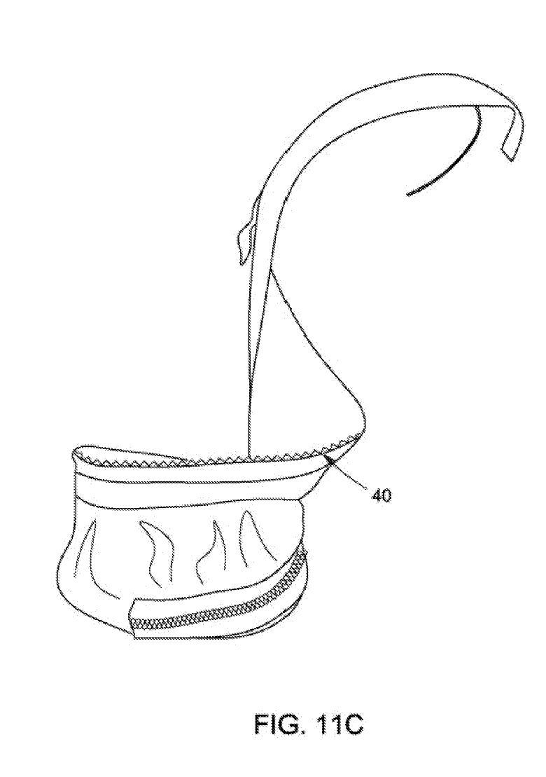

FIGS. 11A-C show another embodiment with a sidewall that containing a means for opening a plant container for easy dirt removal and/or transplanting, such as zippers, ties, hook and loop type fasteners, etc. Here, the means for opening is a zipper forming a spiral along the sidewall for even easier removal of the plant container.

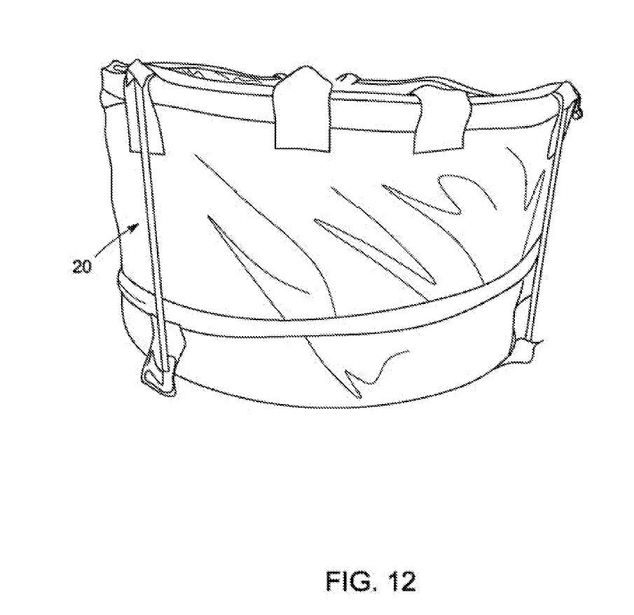

The skeletal support 20 can be integral and non-removable or removable as shown in FIG. 12. A removable skeletal structure can aid in easier cleaning and/or storage.

It is to be understood that a combination of different shaped skeletal structures can be used to form a variety of different shapes. For instance, FIGS. 10A and 10B demonstrate vertical skeletal supports that connect a square shaped base with a circular upper rim skeletal structure.

It is be understood that the pot can have handles or be absent of handles as shown in FIGS. 6, 8, 10A, 10Bb, 11A, 11B, and 11C.

The vertical supports and any skeletal structure can be integral and non-removable or removable as shown in FIG. 12. A removable skeletal structure can aid in easier cleaning and/or storage.

It is to be understood that the skeletal support structure can be comprised of any type of corrosion resistant or non-corrosion resistant metal (steel, etc), composite, plastic, fiberglass, wood or any other organic material. The skeletal support structure can be designed to be removable for easy washing and/or handling. Skeletal structures can extend past the upper rim of the container to form a structural support for the plant stalk and branches themselves. The sidewalls may contain zippers, ties, hook and loop type fasteners, or any other method for opening plant pot sidewall for easy dirt removal and/or transplanting.

What is claimed is:

1. A plant container for reducing root circling and promoting air pruning, the plant container comprising:
an open top portion;
a closed bottom portion;
at least one sidewall extending from the open top portion to the closed bottom portion; and
and a rigid skeletal support on the inside or outside of the side wall;
whereby the open top portion, the closed bottom portion and the side wall is made of fabric.

2. The plant container of claim 1 further comprising at least one pair of handles woven on either side of the side wall for easy transport.

3. The plant container of claim 1, wherein the skeletal support has a spring-like quality, including a wire, plastic, or other malleable material, allowing the skeletal support to be collapsed to a flat position.

4. The plant container of claim 1, wherein the skeletal support is woven on the inside or outside of the at least one sidewall.

5. The plant container of claim 1, wherein the skeletal support is spiral shaped and threaded through a spiral shaped sleeve woven around the at least one sidewall.

6. The plant container of claim 1, wherein the skeletal support has vertical supports perpendicular to a bottom or top portion of the plant container to form a container shape.

7. The plant container of claim 1, wherein the shape of the skeletal support is a square, a rectangular, a polygon, an octagonal, or other shape whose volume can be filled with a plant medium.

8. The plant container of claim 1, wherein the closed bottom portion is water or air permeable.

9. The plant container of claim 1, wherein the at least one side call comprises means for opening the plant container for easy dirt removal or transplanting, including a zipper forming a spiral along the at least one side wall for easy dirt removal.

10. The plant container of claim 1, wherein the closed bottom portion is treated with resin or other treatment to provide resistance to wear and tear.

11. The plant container of claim 1, wherein the closed bottom portion comprises a pair of fasteners in the inner surface of the closed bottom portion and a pair of fasteners in the outer surface of the closed bottom portion.

12. The plant container of claim 1, wherein the open top portion comprises a pair of hook and loop type fasteners and the outer surface of the closed bottom portion comprises a corresponding pair of hook and loop type fasteners.

13. The plant container of claim 12, wherein the pair of hook and loop type fasteners can attach to itself to form a loop for holding utility items.

14. The plant container of claim 12, wherein the pair of hook and loop type fasteners form part of a strap, long enough to fold across the open top portion and attach to another side of the open top portion.

15. The plant container of claim 12, wherein the pair of hook and loop type fasteners form part of a strap, long enough to fold across the open top portion, when the plant container is folded into a figure eight, and attach to another side of the open top portion.

16. The plant container of claim 1, wherein the fabric is a non-woven geotextile fabric.

17. The plant container of claim 1, wherein the rigid skeletal support extends beyond an upper rim of the open top portion.

18. The plant container of claim 1, wherein the at least one sidewall contains a means for opening the at least one sidewall for easy dirt removal and/or transplanting.

19. The plant container of claim 1, wherein the rigid skeletal support extends past the upper top portion for structural support of plant stalks and branches.

20. The plaint container of claim 1, wherein the rigid skeletal support is removable from the plant container.

21. A plant container comprised of rings enveloped in fabric to form sidewalls, the fabric immediately surrounding the ring's edges form borders of the sidewalls, wherein each border of the sidewalls are sewn to an adjacent border of another sidewall, wherein the sidewalls are collapsible to a bottom portion of the plant container.

22. The plant container of claim 20, wherein, when the sidewalls are collapsed, the overall shape of the plant container in collapsed form is the same shape and size of one sidewall.

23. The plant container of claim 20, wherein the plant container can take various geometric shapes based on the number of rings sewn together.

24. The plant container of claim 20, wherein a top of the plant container comprises folded over fabric that resists overexpansion of the plant pot, and helps to maintain the plant container in an upright position.
